(19) United States
(12) Patent Application Publication
(10) Pub. No.: US 2026/0228098 A1
(43) Pub. Date: Aug. 6, 2026

(54) EFFICIENT IDENTIFICATION OF DATA GAPS IN DATA SETS FOR VIRTUAL SENSORS

(71) Applicant: Robert Bosch GmbH, Stuttgart (DE)

(72) Inventors: Matthias Woehrle, Bietigheim-Bissingen (DE); Martin Butz, Steinheim An Der Murr (DE); Michael Hilsch, Gaertringen (DE)

(21) Appl. No.: 19/466,752

(22) Filed: Feb. 2, 2026

(30) Foreign Application Priority Data
Feb. 5, 2025 (DE) 10 2025 104 288.8

(51) Int. Cl. G06F 11/26

(52) U.S. Cl. CPC G06F 11/261

(57) ABSTRACT

A computer-implemented method for determining a data set suitable for training and/or testing a virtual sensor is disclosed. The method includes (i) receiving first information, wherein the first information defines a non-empty first subset in a Cartesian product of value sets, wherein at least one value set comprises at least two values, and (ii) calculating second information, wherein the second information defines a non-empty second subset in a third subset of the Cartesian product, and the second subset is at least partially or entirely contained in the complement of the first subset in the third subset, wherein the third subset is a real subset of the Cartesian product or the Cartesian product.

This application claims priority under 35 U.S.C. § 119 to patent application no. DE 10 2025 104 288.8, filed on Feb. 5, 2025 in Germany, the disclosure of which is incorporated herein by reference in its entirety.

### BACKGROUND

Data-based models are increasingly used in control software, for example, to calculate the input signals for an actuator or to switch to a different mode of operation. They often replace real sensors with software. For example, these models are trained with a training data set from n data points—e.g. (p1, x1, y1), (p2, x2, y2), . . . , (pn, xn, yn).

Here, for example, each data point can comprise a triple including a working point vector p, which contains, for example, one or more settings on a test bench. The triple may further include an input datum x (e.g., an input to a virtual sensor) and an associated label y describing the prediction (e.g., the optimal output) of the virtual sensor. p and x may include similar elements. For example, the data-based model only uses x as an input for training and prediction. A test data set may be defined in this way or similarly.

The data-based model is designed to work (adequately) well at all work points. Therefore, a training data set and/or test data set must contain a sufficiently complete work area, because otherwise neither learning nor estimating the expected accuracy of the virtual sensor can be achieved. Therefore, it takes representative and covering operational cycles that include all operating points p occurring in the operation. For the selection of the operating points and new experimental areas, domain-specific heuristics are often selected. Likewise, known algorithms can be used, e.g., in the area of discrete data, the so-called combinatorial testing (e.g., pairwise testing). In particular, data gaps (that are too large) in the training data set and/or the test data set should be avoided.

The disclosure may therefore be based on the problem of identifying and then closing data gaps in one or more data sets that may be utilized for training and/or testing a virtual sensor.

### SUMMARY

A first general aspect of the present disclosure is related to a computer-implemented method for determining a data set suitable for training and/or testing a virtual sensor. The method includes receiving first information, wherein the first information defines a non-empty first subset in a Cartesian product of value sets, wherein at least one value set (e.g., each value set) comprises at least two values. The method further comprises calculating second information, wherein the second information defines a non-empty second subset in a third subset of the Cartesian product, and the second subset is at least partially or entirely included in the complement of the first subset in the third subset, wherein the third subset is a true subset of the Cartesian product or the Cartesian product.

A second general aspect of the present disclosure is related to a computer-implemented for training and/or testing a virtual sensor. This method includes training and/or testing the virtual sensor based on a data set determined according to the computer-implemented method for determining a data set suitable for training and/or testing a virtual sensor according to the first general aspect (or an embodiment thereof).

A third general aspect of the present disclosure relates to a computer system adapted to perform the method for determining a data set suitable for training and/or testing a virtual sensor according to the first general aspect (or an embodiment thereof) and/or the computer-implemented method for training and/or testing a virtual sensor according to the second general aspect (or an embodiment thereof).

A fourth general aspect of the present disclosure relates to a computer program or signal, which is adapted to perform the method for determining a data set suitable for training and/or testing a virtual sensor according to the first general aspect (or an embodiment thereof) and/or the computer-implemented method for training and/or testing a virtual sensor according to the second general aspect (or an embodiment thereof).

A fifth general aspect of the present disclosure relates to a computer-readable medium that stores and/or contains the computer program or signal according to the fourth general aspect (or an embodiment thereof).

The method according to the first aspect (or an embodiment thereof) proposed in this disclosure is directed to identifying data gaps in a data set that can be utilized for training and/or testing a virtual sensor. Thus, this method allows one or more data gaps in the data set to be identified and (if desired) closed.

An (if necessary iterative) design of experiment (DoE) for mixed continuous/discrete value sets (e.g. rooms) is thus also possible. By utilizing an efficient representation and describing relevant and irrelevant sub-spaces, at least one new data point (thereby at least one new experimental point) can be selected efficiently even for larger spaces. The data set may be extended by this at least one new data point. This will then close a corresponding data gap.

The described efficient implementation allows for the description of large input spaces. Likewise, an efficient implementation of a runtime monitor may be derived.

The virtual sensor may determine information about a technical system based on a virtual sensor signal. This can be seen as an indirect measurement, as one or more other magnitudes are typically measured by one or more real sensors on which an input for the virtual sensor and then also the output of the virtual sensor depend. For example, the technical system may be an at least partially autonomous system that is controlled, regulated, and/or monitored based on the virtual sensor (output). For example, the technical system, particularly the at least semi-autonomous system, may include (or be) a robot/vehicle that is at least partially self-propelled, a mobile work machine, an e-motor system, or a refrigerator. For example, a mobile work machine may be controlled via a virtual sensor (e.g., via an inverse model). In another example, via a virtual sensor, it can be detected whether the door of a refrigerator is not completely closed (door gap detection). Here, it can be monitored whether the current work area is supported for controlling a compressor of the refrigerator. In another example, one or more temperatures of a stator and/or rotor in an e-motor system may be determined via a virtual sensor that are difficult or impossible to measure with real sensors.

The efficient representation and processing of the third subset of the Cartesian product (e.g. of a combinatorial space) is possible, e.g. with the help of morphological boxes (also: Zwicky boxes) and so-called logical rules. In this case, for example, the discrete space can be described with the help of so-called dimensions, which each consist of a finite number of discrete exclusive alternatives. The total space considered here is precisely that created by the formation of the Cartesian product of the dimensions. In this space, sub-spaces can now be described using logical rules. The method enables the successive specification of such rules, e.g. for the formation of application-relevant sub-spaces. For this purpose, so-called further logical rules (thereby rule suggestions) for the space not yet sufficiently covered can be calculated and, if necessary, made available to the user. Various options are available for selecting these further logical rules. In the use proposed herein, in particular as compact as possible rule descriptions that do not overlap with the already sufficiently covered space can be most relevant. In the application, these can now describe the new work areas, which can still be supplemented to the present, described data set, e.g. training data set and/or test data set. This enables efficient use of the data points to achieve suitable coverage of the space without having to collect an unnecessary number of data points.

In addition, t-way or combinatorial testing aims to capture all combinations of t-fold subsets of the dimensions in the data set and offers further structuring and control of the most suitable control proposals for increasing the data point. This can still achieve an improved balance of the data set used. Namely, a logical rule described with the above methodology results in a natural connection to the criterion used in t-way testing. Because in an exemplary Cartesian product {a1, a2, a3}×{b1, b2}×{c1, c2} of three dimensions, a logical rule a1∧b2 (i.e., position 2) in the disjunctive normal form covers all combinations of the dimensions not bound therein (e.g., any values c1, c2). Further, for example, for a space with seven dimensions, a logical rule whose disjunctive normal form is based on only two of the seven dimensions, is already immediately sufficient, since it covers all five-fold combinations (i.e. 5-way combinations) of the other five dimensions.

The following also applies, for example: If the shortest possible control proposal in the disjunctive normal form is based on e.g. 4 dimensions (i.e., position 4), this control suggestion already covers all 3-fold combinations (i.e. 3-way combinations), since in this case there is at least one logical rule that already covers them. Otherwise, exactly this would be a shorter rule proposal.

### BRIEF DESCRIPTION OF THE DRAWINGS

FIG. 1 schematically illustrates an exemplary (and typical) constellation of a first, second and third subset of a Cartesian product.

FIG. 2 schematically illustrates exemplary embodiments of the method for determining a data set suitable for training and/or testing a virtual sensor.

### DETAILED DESCRIPTION

The method 100 is directed to determining a data set suitable for training and/or testing a virtual sensor. Alternatively or additionally, the method 100 may be directed to assess whether and to what extent a data set is suitable for training and/or testing a virtual sensor.

A method 100 for determining a data set suitable for training and/or testing a virtual sensor is disclosed. The method 100 is at least predominantly or entirely computer-implemented.

The method 100 comprises, as illustrated schematically in FIG. 2, receiving 120 first information, wherein the first information defines a non-empty first subset 10 in a Cartesian product 40 of value sets, wherein at least one value set (typically also each value set) comprises at least two values.

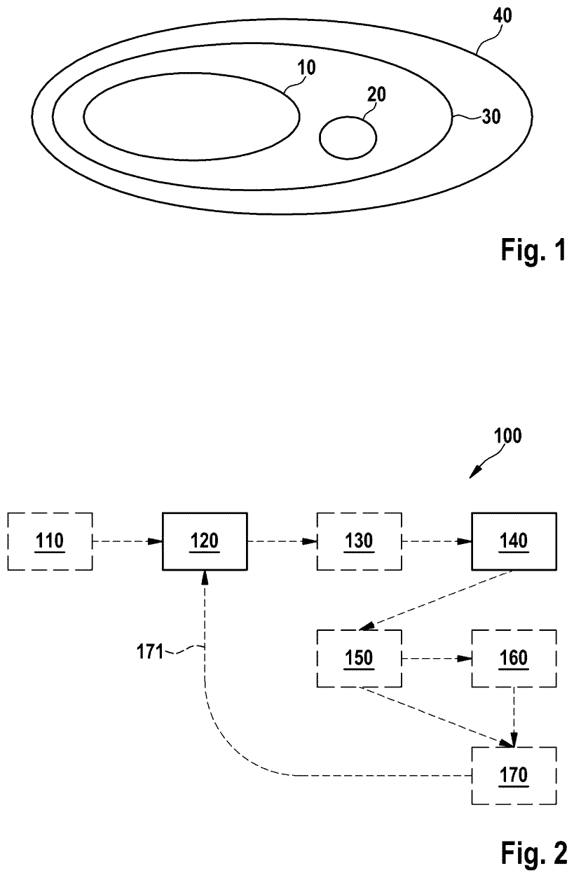

The method 100 further comprises, as illustrated schematically in FIG. 2, calculating 140 second information, wherein the second information defines a non-empty second subset 20 in a third subset 30 of the Cartesian product 40 and the second subset 20 is at least partially or entirely (as schematically illustrated in FIG. 1) included in the complement of the first subset 10 in the third subset 30, wherein the third subset 30 (as schematically illustrated in FIG. 1) is a true subset of the Cartesian product 40 or the Cartesian product 40.

FIG. 1 is a set representation that may be detached from the dimension of Cartesian product 40.

A data set may comprise one or more data points, generally a plurality of data points. For example, a data point may include an operating point p and/or an input data x for a virtual sensor. Additionally, a data point may also comprise a label y, i.e., a response of the virtual sensor as a function of p and/or x. One or each of p, x, and y may be multi-dimensional for a data point, i.e., having multiple components. A plurality of n data points may be designated by (p1, x1, y1), (p2, x2, y2), . . . , (pn, xn, yn) (p1, x1, y1), (p2, x2, y2), . . . , (pn, xn, yn), wherein one or more of, for example, p1, x1, and y1 may comprise one or more components.

In the case of door gap detection on the refrigerator, the virtual sensor may obtain at least one temperature (measured by another sensor) as the input date x and determine whether the door of the refrigerator is completely closed or not (label y). This detection may depend, for example, on other parameters, e.g., on a type of product and whether warm, vaporizing food has been placed in the refrigerator. Such parameters may, for example, define an operating point p here. For example, a machine learning model may be trained here as mapping from x to y, and then applied. By the latter, the virtual sensor may be implemented. Alternatively, a machine learning model may be trained here as mapping from (x, p) to y and then applied.

The third subset 30 may emerge from the Cartesian product 40 by one or more exclusion criteria. The method 100 may define the third subset 30 based on the one or more exclusion criteria. Alternatively, the method may comprise receiving the third subset 30.

The Cartesian product 40 and its value sets—optionally limited to the third subset—may represent a system context for a technical system (e.g., a refrigerator) controlled, regulated, and/or monitored based on the virtual sensor.

In other words, Cartesian product 40 is primarily about the third subset 30 after consideration of the one or more exclusion criteria. This can be seen as an operating area or as operating areas. Namely, the third subset 30 is to be sufficiently covered by data points associated with the first subset 10. If this is not yet the case, a second subset 20 is formed according to the procedure, to which at least one data point 150 can be defined, so that the data points associated with the first subset 10 and the at least one defined data point 150 sufficiently cover the third subset.

The terms first and second information are used to, for example, as alternative and/or implicit definitions of the first and second subsets.

The method 100 may further comprise, as an option shown in FIG. 2, calculating 110 the first information, particularly the first subset 10, from a plurality of data points determined for the virtual sensor (e.g., from measurements with an associated physical sensor). The first subset 10 may include elements associated with these data points, e.g., by an equivalence relation. For example, the first subset 10 may already comprise these data points.

The method 100 may further comprise receiving the plurality of data points determined for the virtual sensor. Receiving 120 the first information may include calculating 110 the first information. Alternatively, as shown schematically in FIG. 2, calculating 110 the first information may precede receiving 120 of the first information.

For example, the first subset may be calculated such that the plurality of data points determined for the virtual sensor adequately covers the first subset.

At least one or each of the value sets may each be a finite discrete subset. Alternatively or additionally, at least one or each of the value sets may be canonically identifiable with a finite discrete subset. An identification may be canonical, for example, if it is the identity mapping on the cross-section of a value set and the respective finite discrete subset. For example, a value set may [0,0.25)∪[0.25, 0.5)∪[0.5, 0.75)∪[0.75, 1) be identified canonically with {0, 0.25, 0.5, 0.75}(e.g., 0.24 equivalent to 0).

The method 100 may comprise discretizing another Cartesian product such that this discretization results in Cartesian product 10. An exemplary discretization of one or more value sets may include forming bins (as in a histogram).

In particular, in the case of value sets as finite discrete subsets, the first information may define the first subset 10 by one or more first logical rules and the second information may define the second subset 20 by at least a second logical rule. This can occur, for example, in a disjunctive normal form, in particular based on literals, which each corresponds to a non-negated or negated value of one of the value sets. A logical rule is in a disjunctive normal form when it is a disjunction (generally linked by ∨, i.e., logical OR) of conjunction terms (generally linked by ∧, i.e., logical AND).

One or more literals may also be defined differently. For example, for a non-finite, non-discrete subset [0,0.25)∪[0.25, 0.5)∪[0.5, 0.75)∪[0.75, 1), a literal may be defined as {x|(x≥0)∧(x<0.25)}. An example of a logical rule in disjunctive normal form may be ((a1=0.25)∧(b2=100))∨((a1=0.5)∧(b2=200))∨((a1=1)), which can also be shortened to (0.25∧100)∨(0.5∧200)∨1.

The third subset 30 can also be defined by one or more third logical rules, particularly in disjunctive normal form. Advantageously, all logical rules may be in the same disjunctive normal form.

Such logical rules represent an efficient representation of relevant and irrelevant subsets (sometimes also sub-spaces), particularly in cases where the Cartesian product 40 consists of a large number of factors (namely the value sets) and/or one or more of the value sets has a large number of values.

Calculating 140 the second information, in particular the second subset 20, may be based on a result of a test criterion, wherein the method 100, as shown as an option in FIG. 2, may include checking 130, based on the first subset 10, whether the test criterion is satisfied.

For example, calculating the second information, in particular the second subset 20, may be based on the result of the test criterion in that it depends on the result of the test criterion whether the second information, in particular the second subset 20, is calculated.

The test criterion may be directed to whether the first subset 10 (i.e., implicitly the data points of the data set) adequately covers the third subset 30. For example, calculating the second information, in particular the second subset 20, can be based on the result of the test criterion in that the second information, in particular the second subset 20, is only calculated if the first subset 10 does not yet adequately cover the third subset 30.

Alternatively or additionally, the test criterion may be directed to whether the first subset 10 covers all t-way testing combinations of values with t=1, . . . , n_max from the third subset 30. For example, t_max may be at least 1, at least 2, or at least 3.

t-way testing combinations may be combinations of t-way testing (also: combinatorial testing). Such a test procedure is summarized in https://www.nist.gov/programs-projects/combinatorial-testing, for example. The special case of pairing method (2-way testing) is explained in https://de.wikipedia.org/w/index.php?title=Pairwise-Methode&oldid=187581611.

As shown schematically in FIG. 1, the second subset 20 may be a true subset of the complement of the first subset 10 in the third subset 30. Thus, here the second subset 20 is a subset of the subset 30, but not the subset 10. Alternatively or additionally, the second subset 20 may also be the complement of the first subset 10 in the third subset 30.

As shown as an option in FIG. 2, process 100 may include defining 150 based on second subset 20, at least one data point to be determined by measurement and/or simulation for the virtual sensor.

The at least one data point (i.e., at least one further data point) may be an element of the second subset 20 or may be associated with an element in the second subset 20 (e.g., by an equivalence relation). In some embodiments, at least one component may not yet be (fully) indicated when defining 150. This at least one component (for example a label y) may then be determined, e.g., in step 160, by measurement and/or simulation for an operating point p and/or for an input data x of the virtual sensor. One or each of p, x, and y may be multidimensional for the at least one (further) data point, i.e., having multiple components.

The at least one data point may be defined by one or more further logical rules, in particular in the disjunctive normal form.

The second subset 20 may comprise or represent uncovered workspaces of the virtual sensor. At the same time, the second subset 20, and in particular its existence, can be seen as insufficient coverage. Based thereon, for example, a test bench may then be scheduled in a relevant work area of the virtual sensor to collect one or more data points therein.

Advantageously, defining 150 can be done such that it is not based on the first subset 10. This is the case, for example, if the at least one data point is not an element of the first subset 10. This prevents further data points from being determined in already sufficiently covered work areas of the virtual sensor. In other words, already sufficiently covered work areas can be skipped. This increases efficiency, which is particularly important in Cartesian products 40 with a large number of factors/subsets and/or subsets with many values.

As shown as an option in FIG. 2, process 100 may include determining 160 of the at least one defined 150 data point by measurement and/or simulation, wherein the data set comprising the plurality of data points determined for the virtual sensor by the at least one 160 data point determined for the virtual sensor is expanded. Determining 160 the at least one defined 150 data point by measurement and/or simulation may be, but need not be, computer-implemented.

As shown as an option in FIG. 2, process 100 may include redefining 170 the first information by merging the first subset 10 and the second subset 20, wherein the resulting amount may be redefined as the first subset 10.

As shown as an option in FIG. 2, the method 100 may further comprise repeating 171 the method 100.

If necessary, the third subset 30 may be adjusted, in particular restricted or extended, prior to repeating 171 (also prior to further iterations).

For example, the method 100 may be repeated 171 until the test criterion is satisfied, wherein the data set comprising the plurality of data points determined for the virtual sensor is deemed suitable for training and/or testing of the virtual sensor.

This also allows for an iterative design of experiment (DoE) for mixed continuous and/or discrete value sets. At the end of such iterations, a sufficiently covered amount (e.g., the first subset from the last iteration or the first subset from the last iteration combined with the second subset from the last iteration) results from system-relevant input variables for the virtual sensor. This may be used for validation and/or verification of the virtual sensor and the technical system.

A specific example of method 100 is discussed below, in particular for the use of Zwicky boxes and control proposals according to the so-called SCODE methodology for deriving a tmax-way coverage of a data set:

In this example, the third subset 30 is the Cartesian product 40, i.e., no exclusion criteria are required here. The Cartesian product 40, hence the third subset 30 here, is defined by the following ways:
Condition1: Temperature=low or medium or elevated
Condition2: Pressure=low or high
Condition3: Setting=on or off
Condition4: Parametrization=low or normal or high end
   In other words, the Cartesian product 40, hence the third subset is already a discrete subset here. This can be most simply (low∨medium∨elevated)∧(low∨high)∧(to∨off)∧(low∨normal∨(high end)) expressed by the logical rule, which is expressed not in the disjunctive normal (disjunction of conjunctional terms), but in normal conjunctiva (conjunction of disjunctional terms). However, the conjunctive normal form may be brought into the disjunctive normal form by equivalent Boolean transformations.

In this example, the first subset may be given by three disjunctions (threefold ∨, i.e., or-linking of four terms) with different characteristics, namely, in the disjunctive normal form:

(low ∧ high ∧ to ∧ (high end))
∨ (medium ∧ high ∧ from ∧ (high end))
∨ (TRUE ∧ TRUE ∧ to ∧ normal)
∨ (elevated ∧ high ∧ TRUE ∧ low)

The Boolean value “TRUE” may also be omitted from the conjunction terms. However, it is useful in the notation used, since a first term in a conjunction term always refers to the Condition1 (temperature), a second term in the conjunction term always refers to the Condition2 (pressure), etc. For example, the conjunction term here means TRUE∧TRUE∧to∧normal that the desire “on” and the parameterization is “normal”, while temperature and pressure can be set as desired. In tooling, the full combinatorial space subtended by the discrete dimensions can be considered here and the coverage of the already specified data points can be expressed by logical rules. In tooling, logical rules are used to represent them as a disjunctive normal form. Thus, the uncovered space can also be determined by a simple complement calculation. In tooling, the internal representation can then be brought back into an optimal compact, normal-form description. These can then be presented to the user in the form of rule proposals.

The not-covered combinations may be calculated in method 100 as follows:

(TRUE ∧ low ∧ TRUE ∧ (low ∨ (high end)))
∨ ((medium ∨ low) ∧ TRUE ∧ TRUE ∧ low)
∨ (TRUE ∧ TRUE ∧ f from ∧ normal)
∨ (low ∧ TRUE ∧ from ∧ TRUE)
∨ (elevated ∧ TRUE ∧ TRUE ∧ (high end))
∨ (medium ∧ TRUE ∧ to ∧ (high end))

These rule proposals can also be brought into the disjunctive normal form. The second subset 20 may be defined based on these rule proposals.

The (compact) logical rules are concrete counter-examples of full coverage of the third subset 30. The fewer dimensions in a logical rule, the larger the uncovered ranges. As in the example above, if two dimensions are minimally included in a logical rule (namely, in each expression there are two TRUE, i.e., actuality 2), then no two-way cover is verifiably achieved, but at least a one-way cover is achieved.

According to these rule proposals, one or more data points can now be added, thus a second subset 20 can be defined, by which the first subset 10 is extended, e.g. the following amount:

(TRUE ∧ low ∧ TRUE ∧ low)
∨ (TRUE ∧ low ∧ TRUE ∧ (high end))
∨ (TRUE ∧ TRUE ∧ from ∧ normal)

Again, the still uncovered combinations may be calculated in an iteration of method 100 as follows:

((medium ∨ low) ∧ hoch ∧ TRUE ∧ low)
∨ (elevated ∧ high ∧ TRUE ∧ (high end))
∨ (low ∧ high ∧ from ∧ (high end))
∨ (medium ∧ high ∧ to ∧ (high end))

These rule proposals can also be brought into the disjunctive normal form. The second subset 20 in this iteration may in turn be defined based on these rule suggestions. Here you can already see that there are now only three 3-way combinations (there is only one TRUE in each printout, i.e., accuracy 3) that are not covered by the existing data points.

According to these rule proposals, one or more data points can now be added, thus a second subset 20 can be defined, by which the first subset 10 is extended, e.g. the following amount:

((low ∨ medium) ∧ high ∧ TRUE ∧ low)
∨ (elevated ∧ high ∧ TRUE ∧ (high end))

Again, the still uncovered combinations may be calculated in a further iteration of method 100 as follows:

(low ∧ high ∧ from ∧ (high end))
∨ (medium ∧ high ∧ to ∧ (high end))

It shows that all 3-way combinations (no TRUE in each printout, i.e., accuracy 4) are covered and only 4-way combinations are missing. The still to be covered is not required in this example, i.e. tmax=3 applies here.

A computer-implemented method 200 for training and/or testing a virtual sensor is further disclosed. This method 200 includes training and/or testing the virtual sensor based on a data set determined according to the computer-implemented method 100 for determining a data set suitable for training and/or testing a virtual sensor. The virtual sensor can be a data-based model that can be trained and tested via known machine learning/artificial intelligence techniques. Testing may also include validating.

As discussed above, a data set may comprise a plurality of data points, each data point comprising a work point p and/or an input data x for a virtual sensor. Additionally, a data point may also comprise a label y, i.e., a response of the virtual sensor as a function of p and/or x.

Thus, a machine learning model (e.g., a neural network) may be trained here as mapping from x to y, and then applied. By the latter, the virtual sensor may be implemented. Alternatively, a machine learning model may be trained here as mapping from (x, p) to y and then applied.

A computer program adapted to perform the computer-implemented method 100 for determining a data set suitable for training and/or testing a virtual sensor is further disclosed. Alternatively or additionally, the computer program may be designed to perform the computer-implemented method 200 for training and/or testing a virtual sensor.

The computer program may, for example, be present in interpretable or compiled form. For execution, it may be loaded (also in portions) into the RAM of a computer, for example, as a bit or byte sequence.

A signal adapted to include, in particular, the computer-implemented method 100 for determining a data set suitable for training and/or testing of a virtual sensor is further disclosed. Alternatively or additionally, the signal may be adapted to perform the computer-implemented method 200 for training and/or testing a virtual sensor.

Furthermore disclosed is a computer-readable medium, which stores and/or contains the computer program or signal. The medium may, for example, comprise one of RAM, ROM, EPROM, HDD, SSD, . . . on/in which the signal is stored.

What is claimed is:

1. A computer-implemented method for determining a data set suitable for training and/or testing a virtual sensor, comprising:
receiving first information, wherein the first information defines a non-empty first subset in a Cartesian product of value sets, wherein at least one value set comprises at least two values; and
calculating second information, wherein the second information defines a non-empty second subset in a third subset of the Cartesian product, and the second subset is at least partially or entirely included in the complement of the first subset in the third subset, wherein the third subset is a real subset of the Cartesian product or the Cartesian product.

2. The method according to claim 1, further comprising:
calculating the first information from a plurality of data points determined for the virtual sensor.

3. The method according to claim 1, wherein at least one or each of the value sets is, or may be canonically identified with, a finite discrete subset.

4. The method according to claim 1, wherein the first information defines the first subset by one or more first logical rules and the second information defines the second subset by at least one second logical rule.

5. The method according to claim 1, wherein the calculating of the second information is based on a result of a test criterion, the method further comprising:
checking, based on the first subset, whether the test criterion is satisfied.

6. The method according to claim 5, wherein the test criterion is directed to whether the first subset sufficiently covers the third subset.

7. The method according to claim 5, wherein:
at least one or each of the value sets is, or may be canonically identified with, a finite discrete subset, and
the test criterion is directed to whether the first subset covers all t-way testing combinations of values with t=1, . . . , n_max from the third subset.

8. The method according to claim 1, wherein the second subset is a real subset of the complement of the first subset in the third subset.

9. The method according to claim 1, further comprising:
defining, based on the second subset, at least one data point to be determined by measurement and/or simulation for the virtual sensor.

10. The method according to claim 9, further comprising:
determining the at least one defined data point by way of measurement and/or simulation, wherein the data set comprises the plurality of data points determined for the virtual sensor extended by the at least one data point determined for the virtual sensor.

11. The method according to claim 8, further comprising:
redefining the first information by merging the first subset and the second subset, wherein the resulting set is redefined as the first subset.

12. The method according to claim 11, wherein:
the calculating of the second information is based on a result of a test criterion, and the method further comprises checking, based on the first subset, whether the test criterion is satisfied.

13. A computer-implemented method for training and/or testing a virtual sensor, comprising:
training and/or testing the virtual sensor based on a data set determined according to the computer-implemented method for determining a data set suitable for training and/or testing a virtual sensor according to claim 1.

14. A computer system designed to:
execute the computer-implemented method for determining a data set suitable for training and/or testing a virtual sensor according to claim 1.

15. A computer program or signal, designed to:
execute the computer-implemented method for determining a data set suitable for training and/or testing a virtual sensor according to claim 1.

16. The method according to claim 1, further comprising:
calculating the first subset from a plurality of data points determined for the virtual sensor.

17. The method according to claim 1, wherein the first information defines the first subset by one or more first logical rules and the second information defines the second subset by each in disjunctive normal form based on literals each corresponding to a non-negated or negated value of one of the value sets.

18. The method according to claim 5, wherein:
at least one or each of the value sets is, or may be canonically identified with, a finite discrete subset,
the test criterion is directed to whether the first subset covers all t-way testing combinations of values with t=1, . . . , n_max from the third subset, and
t_max is at least 1, at least 2 or at least 3.

19. The method according to claim 12, wherein:
the data set comprises the plurality of data points determined for the virtual sensor is considered suitable for training and/or testing the virtual sensor.

20. The method according to claim 1, wherein the calculating of the second subset is based on a result of a test criterion, the method further comprising:
checking, based on the first subset, whether the test criterion is satisfied.
